(19) United States
(12) Patent Application Publication
(10) Pub. No.: US 2026/0016107 A1
(43) Pub. Date: Jan. 15, 2026

(54) CONNECTORS

(71) Applicant: TOGO SEISAKUSYO CORPORATION, Togo-cho, Aichi-gun, Aichi-ken (JP)

(72) Inventors: Takako KAWAMURA, Togo-cho, Aichi-gun, Aichi-ken (JP); Genta SATO, Togo-cho, Aichi-gun, Aichi-ken (JP)

(21) Appl. No.: 18/992,759

(22) PCT Filed: May 25, 2023
(86) PCT No.: PCT/JP2023/019526

§ 371 Date: Jan. 9, 2025

(30) Foreign Application Priority Data
Jul. 11, 2022 (JP) 2022-111119

(51) Int. Cl. F16L 37/088

(52) U.S. Cl. CPC F16L 37/0885

(57) ABSTRACT

A connector with a connector body and a retainer. The retainer has a pair of legs, a detecting claw on the legs to allow the legs elastically to deform radially outward when a pipe is inserted, a removal stopper to prevent the pipe from being removed from the connector body, and a locking claw protruding axially from the legs. The connector body includes a first restricting surface for restricting movement of the locking claw to hold the retainer in a temporary-locked position, and a second restricting surface for restricting movement of the locking claw from the temporary-locked position to a fully-locked position, a guide groove to allow the locking claw to move between the first and second restricting surfaces when the legs are deformed, and a guide surface to guide the locking claw toward the fully locked position when the legs are deformed further radially outward.

### CROSS-REFERENCE TO RELATED APPLICATIONS

The present application is a 35 U.S.C. § 371 U.S. National Phase entry of, and claims priority to, PCT Application PCT/JP2023/019526, filed May 25, 2023, which claims priority to Japanese Patent Application No. 2022-111119, filed Jul. 11, 2022, which is hereby incorporated herein by reference in its entirety for all purposes.

### BACKGROUND

One embodiment of the present disclosure relates to connectors for connecting pipes.

Prior art literatures, for example, JP6311073B and JP5518522B, disclose a connector used for connecting pipes. The connector has a tubular connector body and a retainer movably connected to the connector body. A hollow channel is formed inside the connector body. A pipe to be inserted into the connector has a bulge protruding radially outward in the vicinity of an end. The pipe is inserted until the bulge moves deeper into the connector body than the retainer to move the retainer from a temporary locked position to a fully locked position. This prevents the bulge from being removed from the connector body by the retainer, which has moved to the fully locked position. The pipe is thus locked into the connector body.

The above-mentioned prior art literatures describe a retainer that automatically moves from a temporary locked position to a fully locked position when a pipe is inserted into the connector body. The retainer has a pair of legs extending substantially orthogonal to the pipe insertion direction. Each of the pair of legs is provided with a detection portion that contacts the bulge of the pipe to elastically deform the legs and a lock portion to lock the retainer to the connector body in the fully locked position. The retainer also has a removal stopper piece that prevents the bulge from being removed when it is moved to the fully locked position.

When the pipe is inserted into a hollow channel of the connector body, the bulge of the pipe passes between a pair of detecting portions. As the pair of detecting portions are pressed against the bulge of the pipe, the pair of legs elastically expand radially outward from each other. Elastic energy is accumulated in the legs that are expanded radially outward. When the bulge moves deeper into the connector body than the pair of detecting portions, the pair of legs attempt to return to their original shape. At this time, the legs are released from the restriction on movement in a direction toward the fully locked position, and the accumulated elastic energy is used to move in a direction toward an end of the legs. As a result, the retainer moves from the temporary locked position to the fully locked position.

As described in the above prior art literatures, automatic locking type retainers convert a slight amount of deformation of the legs in the radial direction into energy to move the legs from the temporary locked position to the fully locked position. Therefore, it was necessary to increase the rigidity of the conventional retainer. This, for example, caused the retainer and the connector body to become larger. It is also necessary to prevent the retainer from being removed in a direction opposite to a direction where the retainer directs to the fully locked position when the pair of legs expands elastically. For this reason, the detecting portions in the temporary locked position were provided in a location closer to the fully locked position than to an axis of the pipe. Therefore, the pair of legs were extended accordingly, resulting in an increase in the size of the retainer.

As described above, conventional automatic locking type connectors have increased in size, for example, to provide rigidity to a retainer or to prevent the retainer from being removed from the connector body. Therefore, a compactly designed automatic locking type connector has been conventionally needed.

### SUMMARY

According to one aspect of the present disclosure, a connector for connecting pipes has a connector body provided with a hollow channel. The connector has a retainer configured to lock a pipe inserted axially into the hollow channel to the connector body. The retainer has a pair of legs that is inserted into the connector body along a plane orthogonal to an axial direction. The retainer has a detecting claw on the leg that contacts a pipe body or a bulge of the pipe to allow the legs to elastically deform radially outward when the pipe is inserted. The retainer has a removal stopper piece that axially opposes the bulge when the pipe is inserted and prevents the pipe from being removed from the connector body. The retainer has a locking claw protruding axially from the leg.

The connector body has a first restricting surface to restrict a movement of the locking claw of the retainer in a removal direction inserted into the connector body, thereby holding the retainer in a temporary locked position. The connector body has a second restricting surface to restrict a movement of the locking claw from the temporary locked position to a fully locked position. The connector body has a guide groove provided between the first restricting surface and second restricting surface to allow the locking claw to move in the radial direction when the legs are elastically deformed radially outward. The connector body has a guide surface that is formed radially outwardly from the first restricting surface and guides the locking claw in the direction toward the fully locked position when the legs are further elastically deformed radially outward.

Therefore, when inserting the pipe into the hollow channel of the connector body, the detecting claw contacts the pipe body of the pipe and moves radially outward. The legs are bent to expand radially outward to accumulate elastic energy. The locking claw moves radially outward in the guide groove. The first restricting surface restricts the movement of the locking claw in the removal direction, and the second restricting surface restricts the movement of the locking claw in the direction to the fully locked position. Therefore, with the retainer held in the temporary locked position, an amount of deformation in the radial direction corresponding to the approximate diameter of the pipe body is ensured and elastic energy is accumulated in the legs. This suppresses energy loss and allows for efficient accumulation of elastic energy. When the detecting claw contacts the bulge, the locking claw moves further radially outward and comes in contact with the guide surface while accumulating even more elastic energy. The guide surface forcibly moves the locking claw in the direction toward the fully locked position. At this time, the function of the second restricting surface to restrict the movement of the locking claw in the direction toward the fully locked position is no longer present. Therefore, the accumulated elastic energy of the legs generated by the legs being pressed to expand in the radial direction by the bulge, is released in response to the movement of the locking claw in the direction toward the fully locked position. As a result, the retainer moves swiftly from the temporary locked position in the direction toward the fully locked position. Thus, as much as possible deformation amount of the legs in the radial direction can be converted into sufficient energy for the retainer to move from the temporary locked position to the fully locked position. Therefore, the retainer can be provided in a compact structure with reduced rigidity. This allows the connector to be compact.

According to another aspect of the present disclosure, when the retainer opens its legs in the radial direction while the pipe body is in contact with the detecting claw near the horizontal plane passing through the axis in the temporary locked position, the interval between the pair of legs becomes wider at the ends, and the force in the removal direction generated in the retainer is restricted by the first restricting surface of the connector body. Therefore, the amount of deformation of the legs in the radial direction can be increased in the temporary locked position. Therefore, the opening width at the ends of both legs becomes in a size corresponding to the maximum outer diameter of the pipe body. This allows a large amount of elastic energy to be accumulated in the legs. In addition, the force in the removal direction of the retainer is restricted by the first restricting surface. Therefore, the legs can ensure the amount of deformation in the radial direction that corresponds to the approximate diameter of the pipe body. Following this motion, the legs deform further in the radial direction due to the bulge, thereby accumulating even more elastic energy. Overall, there is no need to increase the rigidity of the legs as long as the amount of deformation is ensured. Thus, sufficient elastic energy can be accumulated in the compactly designed legs to move the retainer from the temporary locked position to the fully locked position.

According to another aspect of the present disclosure, the detecting claws may be provided at the ends of the legs and may include an inclined surface on a front side of the pipe insertion direction that is inclined with respect to the insertion direction. Therefore, when the end of the pipe contacts the inclined surface, the force to insert the pipe in the axial direction may be efficiently converted into a force to open the legs radially outward. Furthermore, by providing the inclined surface at the end of the leg, the legs can be opened radially outward using the principle of leverage. As a result, the leg can be made shorter, allowing the connector to be compact after the pipe is assembled.

According to another aspect of the present disclosure, the second restricting surface may be inclined to approach the first restricting surface toward the radially outward direction. Therefore, the inclination of the second restricting surface may prevent unintended movement of the retainer, even when, for example, a force to press the retainer in the direction toward the fully locked position is applied while the retainer is positioned in the temporary locked position.

According to another aspect of the present disclosure, the guide surface may be formed to be planar. Therefore, the locking claw moves along the planar guide surface when it moves to the fully locked position. This helps to reduce energy loss due to the contact between the locking claw and the guide surface.

According to another aspect of the present disclosure, the connector body may have a guide inclined surface on the opposite side of the first restricting surface in a direction toward the fully locked position. The guide inclined surface may be inclined to guide the locking claw radially inward when the retainer is temporarily locked to the connector body. Therefore, the locking claw is guided to the temporary locked position in the guide groove by the guide inclined surface and is prevented from being removed out of the guide groove. Furthermore, the locking claw can be guided along the guide inclined surface by a simple operation to insert the retainer into the connector body. This allows the retainer body to be easily assembled so as not to be removed out of the connector body.

According to another aspect of the present disclosure, the retainer may have a retainer body with a pair of legs extending from both ends. The retainer may have an auxiliary removal stopper piece protruding from the retainer body in the same direction as the extending direction of the legs. The auxiliary removal stopper piece may axially oppose to the bulge inserted into the hollow channel to prevent the pipe from being removed from the connector body. Therefore, the removal stopper piece and the auxiliary removal stopper piece work together to more reliably prevent the pipe from being removed from the connector body. Moreover, the auxiliary removal stopper piece may be provided while maintaining the retainer compact.

According to another aspect of the present disclosure, the locking claw may extend from the legs in the pipe insertion direction. Therefore, the first restricting surface, the second restricting surface, the guide groove and the guide surface, which are engaged with the locking claw, are disposed at the back side of the pipe insertion direction. Therefore, the protrusion amount of the connector body in the insertion direction can be suppressed. This allows the connector to be compact.

### BRIEF DESCRIPTION OF DRAWINGS

FIG. 1 is a perspective view of a connector according to an embodiment of the present disclosure with a pipe assembled.

FIG. 2 is an exploded perspective view of the connector.

FIG. 3 is a rear view of the connector with the pipe assembled.

FIG. 4 is a cross-sectional view taken along a line IV-IV of FIG. 3.

FIG. 5 is a perspective view of the connector before the pipe is assembled.

FIG. 6 is a cross-sectional view of a connector body taken along a line VI-VI of FIG. 4.

In FIG. 6, the pipe and a retainer are omitted for convenience.

FIG. 7 is a rear view of the retainer as seen from a rear side of a pipe insertion direction.

FIG. 8 is a front view of the retainer as seen from a front of the pipe insertion direction.

FIG. 9 is a cross-sectional view of the retainer taken along a line IX-IX of FIG. 7.

FIG. 10 is a cross-sectional view of the connector before the retainer is assembled taken along a line X-X of FIG. 4.

FIG. 11 is a cross-sectional view of the connector with the retainer assembled taken along the line X-X of FIG. 4.

FIG. 12 is a cross-sectional view of the connector before the pipe is assembled taken along the line X-X of FIG. 4.

FIG. 13 is a cross-sectional view of the connector when the pipe is inserted taken along the line X-X of FIG. 4.

FIG. 14 is a cross-sectional view of the connector when a bulge is passing through taken along the line X-X of FIG. 4.

FIG. 15 is a cross-sectional view of the connector after the pipe is assembled taken along the line X-X of FIG. 4.

### DETAILED DESCRIPTION

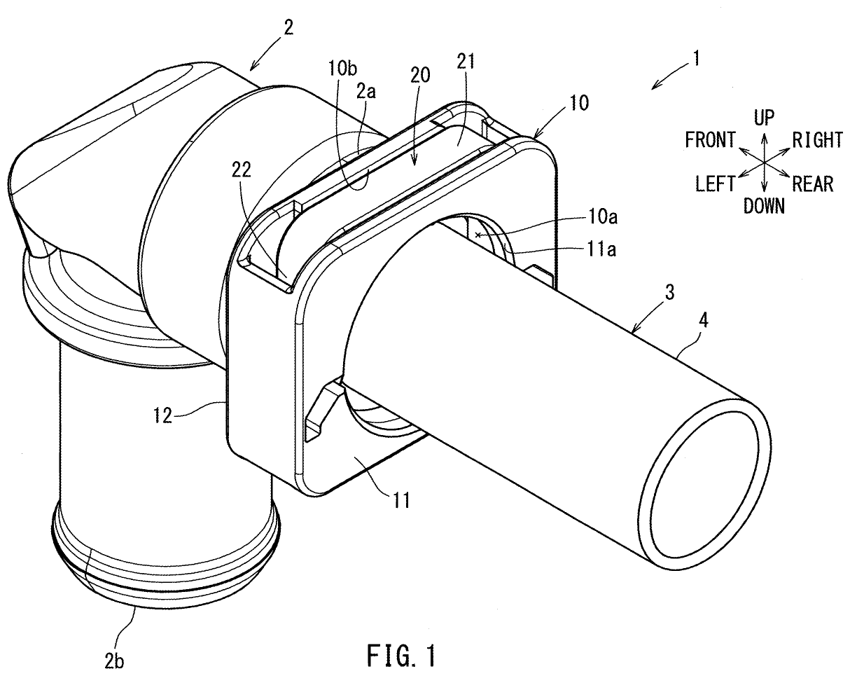

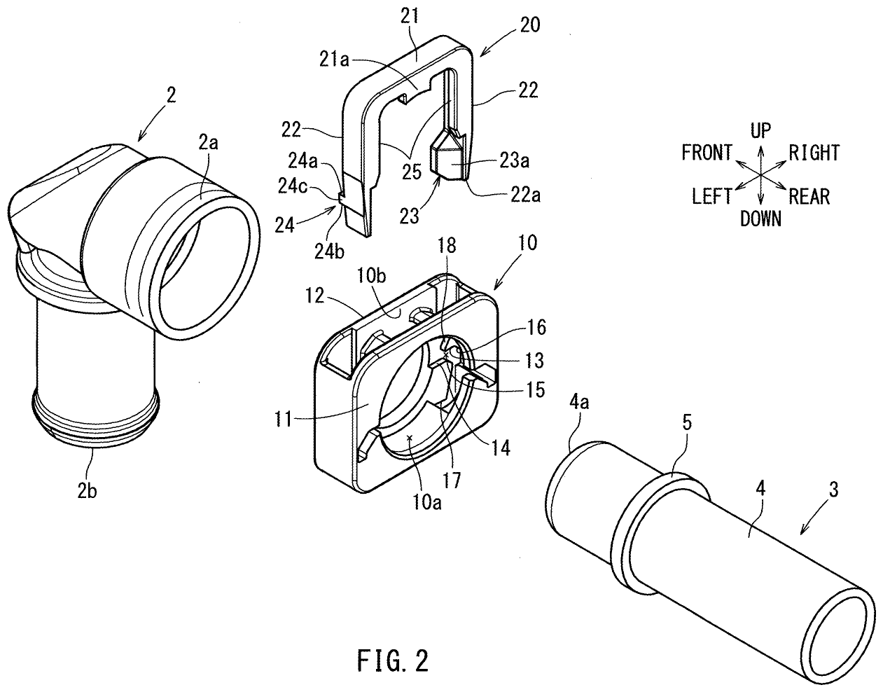

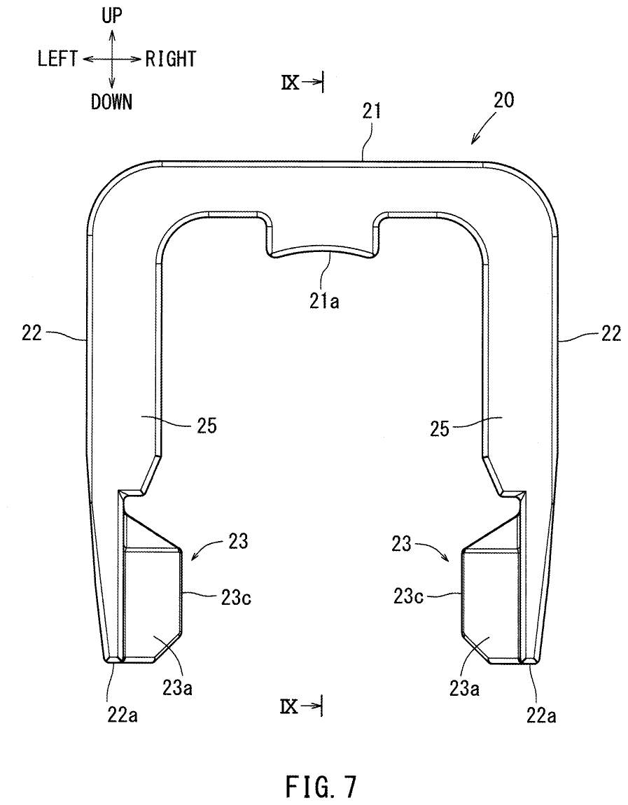

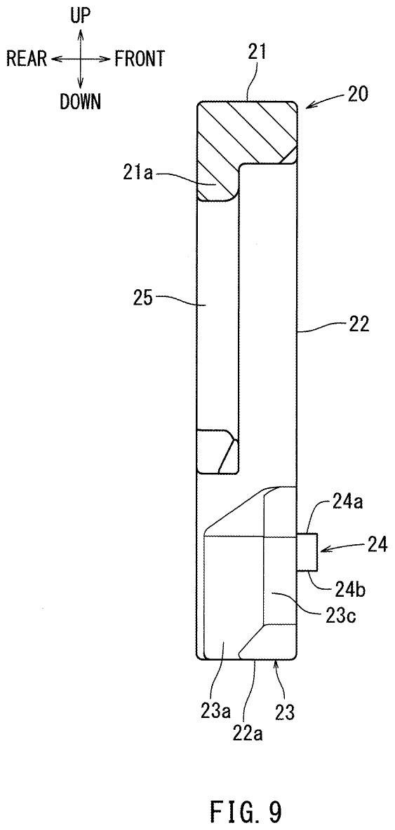

One embodiment of the present disclosure will be described with reference to FIGS. 1 to 15. As shown in FIGS. 1 and 2, a connector 1 has a pipe portion 2 in a form of an elbow pipe, a connector body 10, and a retainer 20. The connector body 10 is integrally attached to the pipe portion 2. The retainer 20 is movably attached to the connector body 10. The pipe portion 2 has a pipe connecting portion 2a at one end to which the connector body 10 is attached and a tube connecting portion 2b at the other end. A tube (not shown) is connected to the tube connecting portion 2b. The connector body 10 has a substantially rectangular box shape. In the center of the connector body 10, a hollow channel 10a is formed, which passes through in a front-rear direction. By inserting the pipe 3 into the hollow channel 10a, the pipe 3 is attached to the connector body 10. The pipe 3, the pipe portion 2, and the tube are thereby fluidly connected as a single flow channel. In the following description, a back side of the pipe 3 in the insertion direction is referred to as a front side, and a front side of the pipe in the insertion direction is referred to as the rear side. An up-down direction is determined by the moving direction of the retainer 20, with the side of the retainer 20 in the temporary locked position referred to as an upper side and with the side of the retainer 20 in the fully locked position referred to as a lower side. A left-right direction is determined as a position as viewed from the backward side in the insertion direction of the pipe 3.

As shown in FIG. 2, the pipe 3 has a cylindrical pipe body 4 with an end 4a. Behind the end 4a, a bulge 5 is provided. The bulge 5 extends radially outward from an outer circumference of the pipe body 4. The bulge 5 has a ring shape extending over the entire circumference in the circumferential direction. The pipe body 4 and the bulge 5 are formed integrally and may be made of metal, such as, for example, aluminum. A flow channel passing through in the front-rear direction is formed in a center of the pipe body 4. An outer circumference of the end 4a is tapered with a diameter decreasing toward the front.

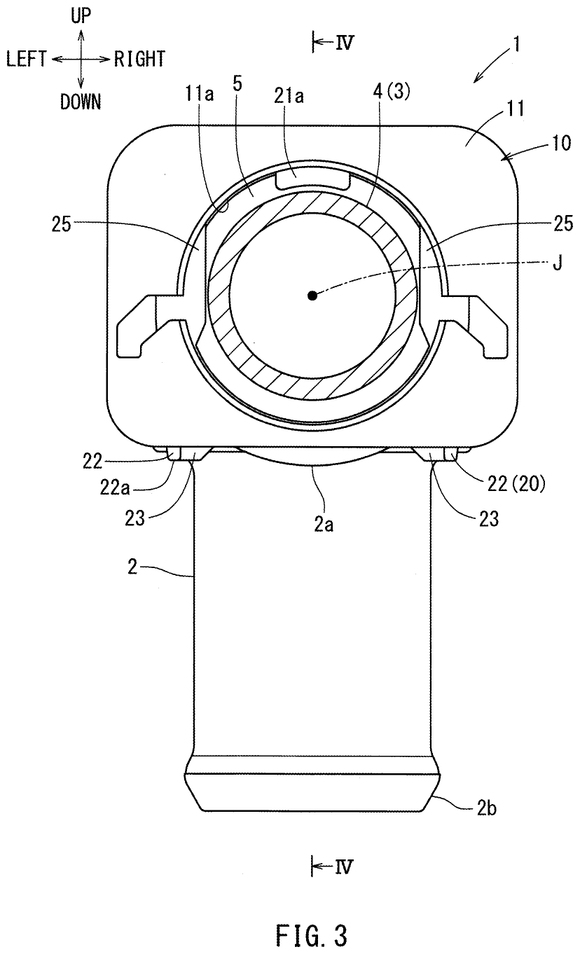

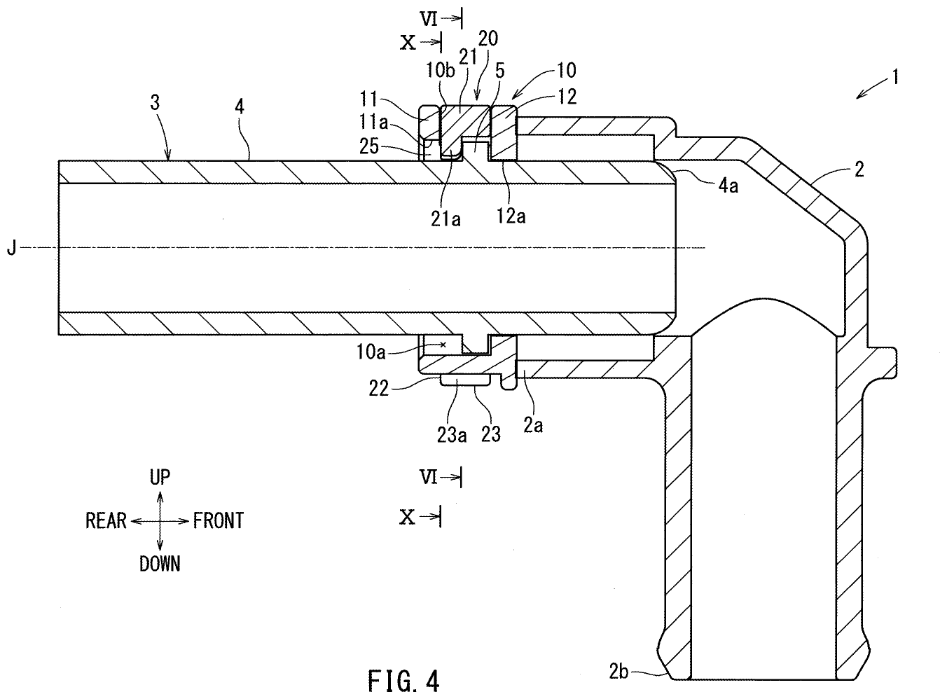

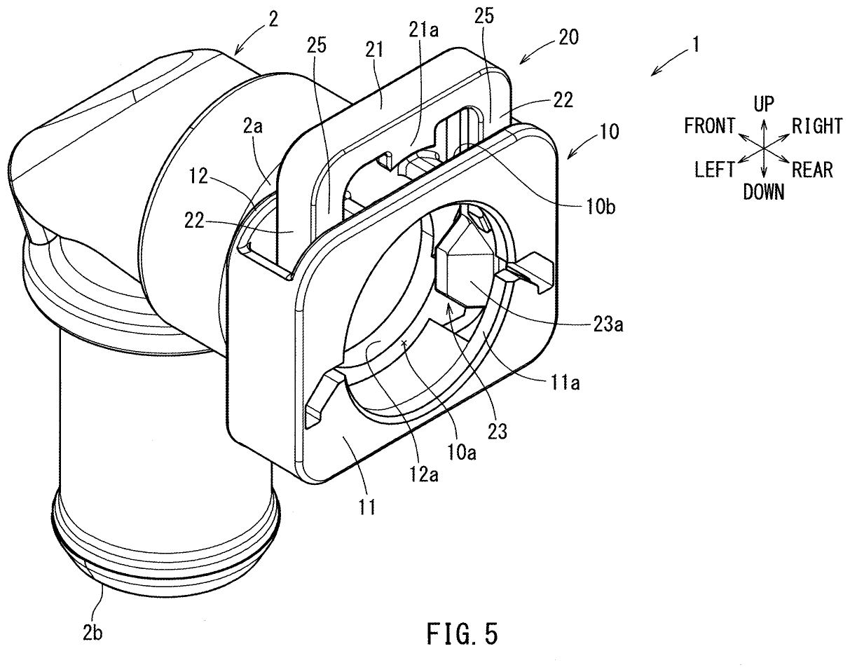

As shown in FIGS. 2 and 5, the connector body 10 has a rear wall 11 at a rear end and a front wall 12 at the front end. Each of the rear wall 11 and the front wall 12 is a rectangular flat plate extending substantially orthogonal to the front-rear direction. The rear wall 11 and the front wall 12 are arranged in the front-rear direction and are connected via side walls. The connector body 10 is formed in one piece and may be made of synthetic resin, for example. A circular rear opening 11a that penetrates in the front-rear direction is provided in the center of the rear wall 11. The rear opening 11a is provided with a diameter that allows the bulge 5 to pass through (see FIGS. 3 and 4). A circular front side opening 12a passing through in the front-rear direction is provided in the center of the front wall 12. The front opening 12a is provided with a diameter that allows the end 4a of the pipe body 4 to pass through but does not allow the bulge to pass through (see FIG. 4). The hollow channel 10a of the connector body 10 is formed between the rear opening 11a and the front opening 12a. An upper opening 10b is provided between an upper end of the rear wall 11 and an upper end of the front wall 12, into which the retainer 20 can be inserted.

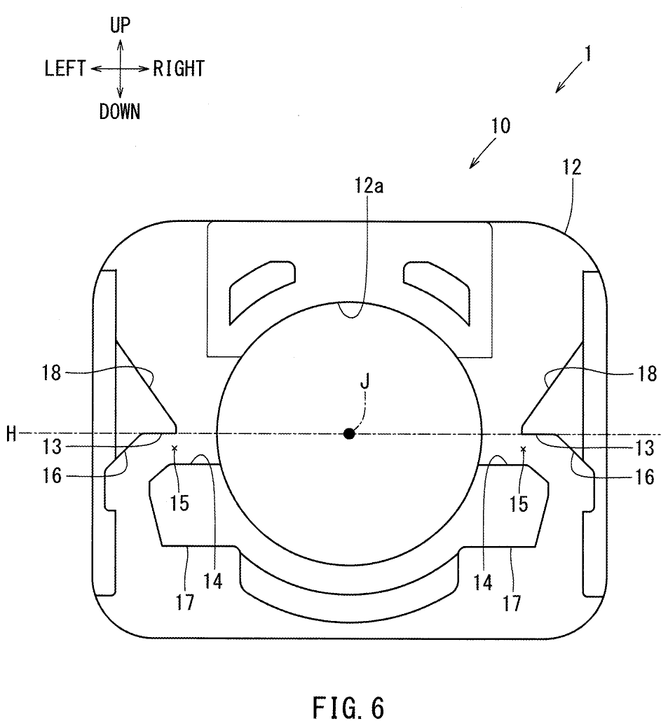

As shown in FIGS. 2 and 6, a rear side of the front wall 12 is formed to have a concave-convex shape protruding or recessed in the front-rear direction. The recess of the concave-convex shape in the front wall 12 is a channel through which locking claws 24 described below are guided. The concave-convex shape of the front wall 12 is symmetrically formed to correspond with the pair of locking claws 24. Hereinafter, only an uneven shape formed in a right area of the front wall 12 will be described, however, a symmetrical similar shape is also formed in a left area of the front wall 12.

As shown in FIGS. 2 and 6, the rear side of the front wall 12 is provided with a first restricting surface 13, a second restricting surface 14, a guide surface 16, a lock surface 17, and a guide inclined surface 18. Each of the surfaces is a side wall of the recess and extends flat in the front-rear direction. The first restricting surface 13 extends in the left-right direction at a left-right interval from the front opening 12a. The first restricting surface 13 is provided at the substantially same height as the horizontal plane H, which passes through the axis J of the pipe 3 and extends in the left-right direction. The first restricting surface 13 extends substantially parallel to the horizontal plane H. The second restricting surface 14 extends from an outer circumferential edge of the front opening 12a to the right. The second restricting surface 14 is provided below the horizontal plane H. The second restricting surface 14 is inclined slightly upward toward the right (outwardly) to approach the first restricting surface 13. The inclination angle of the second restricting surface 14 with respect to the first restricting surface 13 may be, for example, 1° to 2°.

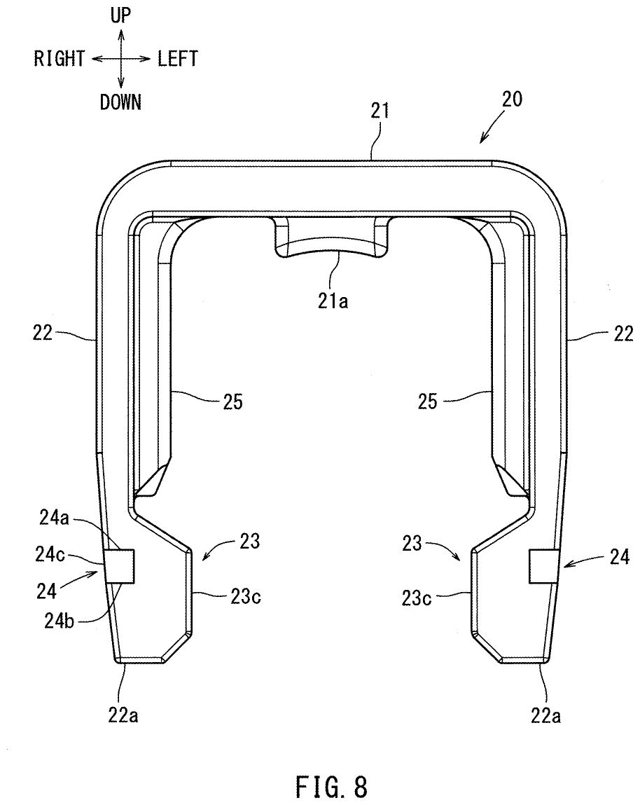

As shown in FIG. 6, a guide groove 15 extending in the left-right direction is formed between the first restricting surface 13 and the second restricting surface 14 in the up-down direction. The guide groove 15 has an up-down width that allows the locking claw 24 (see FIG. 8) to move in the left-right direction. The up-down width of the guide groove 15 is slightly larger than an up-down width of the locking claw 24. In particular, at a right end (outer end) of the guide groove 15, the up-down width of the guide groove 15 is approximately the same as the up-down width of the locking claw 24 and the gap between the locking claw 24 is minimal. The guide surface 16 is formed continuously with a right end of the first restricting surface 13 and extends flatly downward to the right side from the right end of the first restricting surface 13. An inclination angle of the guide surface 16 with respect to the first restricting surface 13 may be, for example, 40° to 50°, and for example, 45°. A gap is provided between the guide surface 16 and a right end (outer end) of the second restricting surface 14 through which the locking claw 24 can pass.

As shown in FIG. 6, the lock surface 17 extends in the left-right direction below the front opening 12a. The lock surface 17 is inclined slightly upward from a corner on a right end toward left (inward). The lock surface 17 is engaged with an upper surface 24a of the locking claw 24 that has moved to the fully locked position (see FIG. 8). The guide inclined surface 18 extends from a left end (inner end) of the first restricting surface 13, inclining upward toward the right. The guide inclined surface 18 is located opposite to the direction toward the fully locked position with respect to the first restricting surface 13. An inclination angle of the guide inclined surface 18 with respect to the first restricting surface 13 may be, for example, 60°. The left end of the first restricting surface 13 and the left end of the guide inclined surface 18 form a gap with the front opening 12a that is slightly larger than the left-right width of the locking claw

As shown in FIGS. 2, 7 to 9, the retainer 20 has a retainer body 21 extending in the left-right direction and a pair of legs 22 extending downward from right and left ends of retainer body 21. The retainer 20 is formed in one piece and may be made, for example, of a synthetic resin with relatively high elasticity. The retainer 20 has a substantially U-shape as viewed from the front-rear direction. In a center of the retainer body 21 is a plate-shaped auxiliary removal stopper piece 21a that extends downward. A plate-shaped removal stopper piece 25 extending inward is provided at an upper portion of each leg 22. An upper end of the removal stopper piece 25 is connected to the retainer body 21. The auxiliary removal stopper piece 21a and the removal stopper pieces 25 are provided at rear side of the retainer 20. The auxiliary removal stopper piece 21a and the removal stopper pieces 25 face a rear side of the bulge 5 with the retainer 20 moved to the fully locked position (see FIG. 4). This prevents the bulge 5 from being removed rearward and keeps the pipe 3 in place.

As shown in FIGS. 2, 7 and 9, the leg 22 extends in the up-down direction substantially orthogonally to the retainer body 21 in its natural state. A detecting claw 23 is provided at an end 22a of the leg 22, which is in contact with the pipe body 4. The detecting claw 23 is provided below the removal stopper piece 25 and extends inward beyond an inner end of the removal stopper piece 25. The detecting claw 23 has a substantially rectangular inclined surface 23a that is oriented rearward and inward. The inclined direction of the inclined surface 23a is the direction toward the center of the retainer 20 in the left-right direction toward the front. The inclined surface 23a extends substantially vertically in the up-down direction with little inclination in the up-down direction. The detecting claw 23 has an inner end face 23c oriented to the other detecting claw 23. The inner end face 23c is located in the front region of the retainer 20 in the thickness direction. And the inner end face 23c is located forward of the auxiliary removal stopper piece 21a and forward of a front side of the removal stopper piece 25.

As shown in FIGS. 2, 8, and 9, the leg 22 has a locking claw 24 protruding forward from the front side. The locking claw 24 is provided at an up-down position at approximately the same height as an upper portion of the detecting claw 23. The locking claw 24 is formed in a rectangular columnar shape having an upper surface 24a, a lower surface 24b, and an outer surface 24c. The upper surface 24a and the lower surface 24b are planar and extend substantially horizontally. An up-down width of the locking claw 24 corresponds to a distance between the upper surface 24a and the lower surface 24b in the up-down direction. A left-right width of the locking claws 24 are approximately the same length as the up-down width of the locking claws 24. The outer surface 24c extends planarly following the outer surface of the leg 22. The locking claw 24 protrudes from the leg 22 with the front-to-rear length substantially equal to the first restricting surface 13, the second restricting surface 14, the guide surface 16, the lock surface 17, and the guide inclined surface 18 formed on the front wall 12 of the connector body 10.

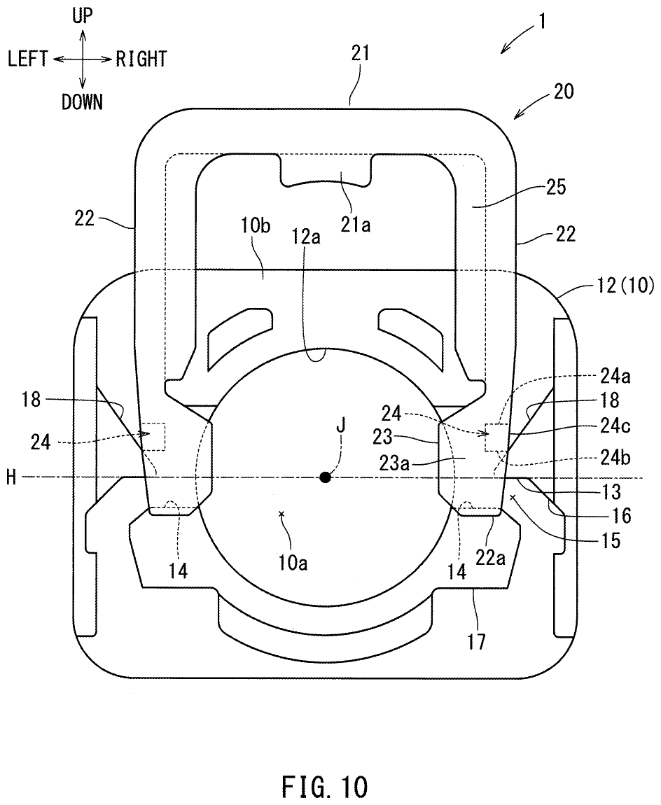

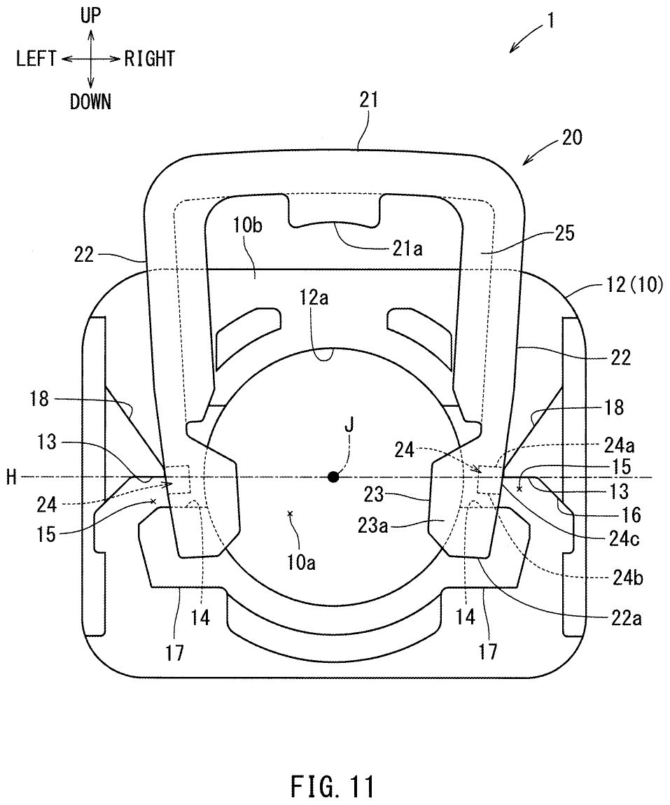

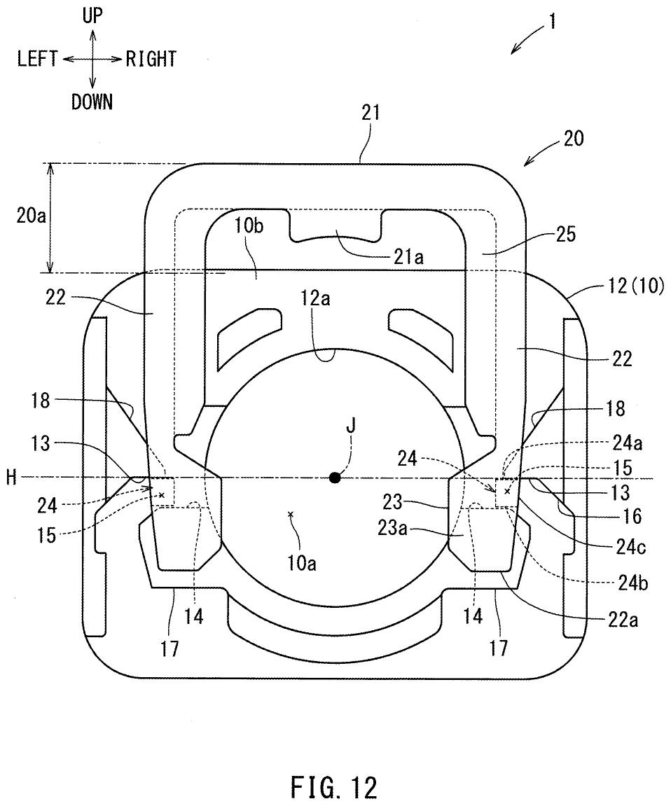

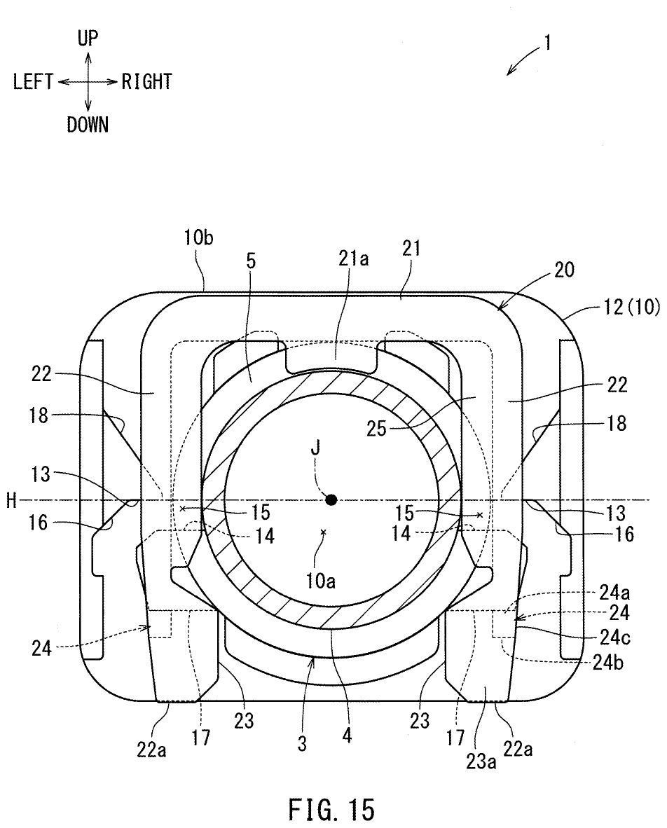

The movement of the retainer 20 when assembled to the connector body 10 will be described with reference to FIGS. 10 to 12. In FIGS. 10 to 15, a ridge line indicating a boundary between the leg 22 and the inclined surface 23a of the detecting claw 23 is not shown to make a hidden line indicating the locking claw 24 easier to see. First, as shown in FIG. 10, the retainer 20 is inserted downward from the upper opening 10b of the connector body 10. The retainer 20 is inserted with the end 22a of the leg 22 located at a lower side. A corner where the lower surface 24b and outer surface 24c of the locking claw 24 intersect is in contact with the guide inclined surface 18. As shown in FIG. 11, when the retainer 20 is pushed further downward, the locking claw 24 is guided by the guide inclined surface 18 and moves toward the inside in the left-right direction. Each leg 22 bends so that the distance in the left-right direction between the ends 22a of the pair of legs 22 is reduced. As shown in FIG. 12, when the locking claw 24 moves to the guide groove 15, the bent leg 22 returns to its natural state where it extends substantially vertical in the up-down direction. The upper surface 24a of the locking claw 24 opposes the first restricting surface 13. The lower surface 24b of the locking claw 24 opposes the second restricting surface 14. Thus, the locking claw 24 is prevented from being removed upwardly from the temporary locked position within the guide groove 15. Also, the locking claw 24 is restricted from moving to the fully locked position. Therefore, the retainer 20 is held in the temporary locked position above the fully locked position (see FIG. 15) by a gap 20a. Furthermore, the second restricting surface 14 is slightly inclined upward to approach the first control surface 13 as it extends outward from the left and right sides. This prevents unintended movement of the retainer 20 even when, for example, a force to press the retainer 20 in the direction toward the fully locked position is applied while the retainer 20 is in the temporary locked position.

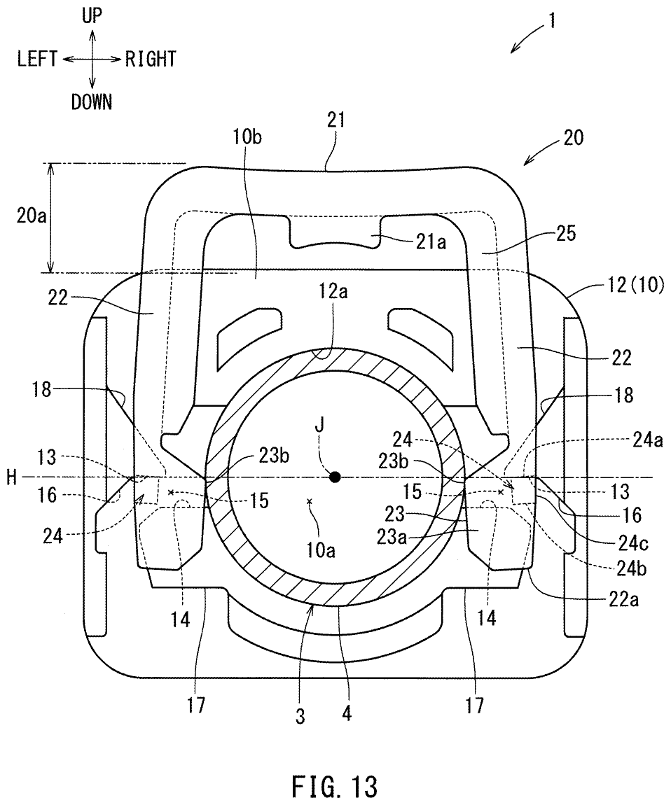

The movement of the retainer 20 in assembling the pipe 3 into the connector body 10 will be described with reference to FIGS. 13 to 15. First, when the pipe 3 is inserted into the hollow channel 10a, the end 4a of the pipe body 4 (see FIG. 4) contacts the inclined surface 23a of the pair of detecting claws 23. When the pipe 3 is inserted further forward, the pair of detecting claws 23 are pushed outward to the left and right by the pipe body 4, respectively, as shown in FIG. 13. At that time, contact areas 23b where the detecting claws 23 are in contact with the pipe body are located in the vicinity of the horizontal plane H that passes through the axis J of the pipe 3 and extends in the left-right direction. The contact area 23b contacts the pipe body 4 within a range at an inclination angle of, for example, −5° to +5° about the axis J (with the inclination angle of the horizontal plane H being 0°, and the counterclockwise direction being positive from the viewpoint in FIG. 13). The pair of legs 22 bend so that the distance between them becomes wider as they extend towards the lower ends 22a. This causes elastic energy to be accumulated in the legs 22.

As shown in FIG. 13, the upper surface 24a and the first restricting surface 13 come in contact with each other to restrict upward removal of the locking claw 24. The lower surface 24b and the second restricting surface 14 come in contact with each other to restrict the downward movement of the locking claw 24 to the fully locked position. The right side locking claw 24 therefore moves to the right along the guide groove 15. The left side locking claw 24 moves to the left along the guide groove 15.

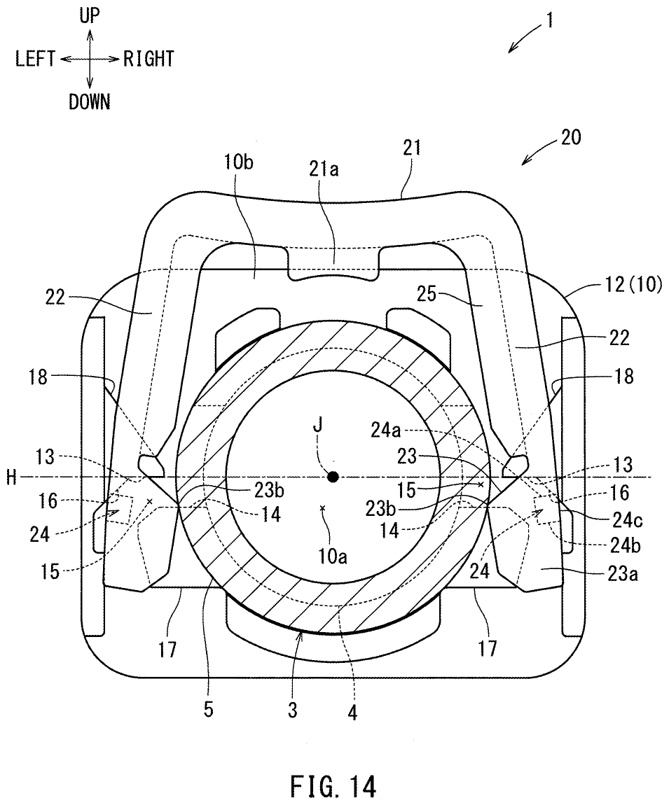

When the pipe 3 is inserted further forward, the bulge 5 reaches between the pair of detecting claws 23, as shown in FIG. 14. At this point, the pair of detecting claws 23 are pushed outward to the left and right by the bulge 5, respectively. The pair of legs 22 is bent such that the distance between the ends 22a is further expanded. This causes the elastic energy accumulated in the legs 22 to increase further. Each of the outer surfaces 24c of the pair of locking claws 24 contacts the guide surface 16. The pair of locking claws 24 are guided by the guide surfaces 16 and are forced to move downward to the fully locked position. Because the guide surfaces 16 are planar, the pair of locking claws 24 move downward without losing momentum. Immediately after the bulge 5 reaches between the pair of detecting claws 23, the force that pushes the pair of detecting claws 23 outward to the left and right is released.

As shown in FIG. 15, in parallel with the downward movement of the pair of locking claws 24, the pair of legs 22 returns to its natural state extending substantially vertically in the up-down direction from the bent state such that the distance between the ends 22a increases. As a result, the upper surfaces 24a of the pair of locking claws 24 are engaged with the lock surfaces 17 to restrict an upward removal. Therefore, the retainer 20 is secured in the fully locked position. The bulge 5 moves from the rear area of the retainer 20 to the front area and is aligned between the pair of detecting claws 23. This places the bulge 5 in front of the removal stopper pieces 25 and the auxiliary removal stopper piece 21a. As a result, the rear side of the bulge 5 opposes axially toward the front sides of the removal stopper pieces 25 and the front side of the auxiliary removal stopper piece 21a. This restricts the rearward movement of the pipe 3 so as to be prevented from being removed out of the connector body 10. The ends 22a of the legs 22 in the fully locked position do not protrude downward from the connector body 10 or protrudes only slightly downward. The retainer body 21 in the fully locked position does not protrude above the connector body 10. Therefore, it can be visually confirmed that the retainer 20 has moved to the fully locked position.

As described above, the connector 1 for piping connection has a connector body 10 with a hollow channel 10a as shown in FIGS. 2, 12, and 13. The connector 1 has a retainer 20 that locks the pipe 3 inserted axially into the hollow channel 10a to the connector body 10. The retainer 20 has a pair of legs 22 inserted into the connector body 10 along the rear wall 11 and the front wall 12 orthogonal to the axial direction. The retainer 20 has a detecting claw 23 provided on the leg 22 that contacts the pipe body 4 or the bulge 5 of the pipe 3 during insertion of the pipe 3 and elastically deforms the legs 22 radially outward. The retainer 20 has a removal stopper piece 25 opposing the axially rear side of the bulge 5, which is aligned with the detecting claw 23 in the axial direction (front-rear direction) to prevent the pipe 3 from being removed out of the connector body 10. The retainer 20 has a locking claw 24 protruding axially from the leg 22.

The connector body 10 has a first restricting surface 13 configured to hold the retainer 20 in the temporary locked position by restricting the movement of the locking claw 24 of the retainer 20 in the removal direction inserted into the connector body 10. The connector body 10 has a second restricting surface 14 configured to restrict the movement of the locking claw 24 from the temporary locked position to the fully locked position. The connector body 10 has a guide groove 15 provided between the first restricting surface 13 and the second restricting surface 14 that allows the locking claw 24 to move in a radial direction when the legs 22 are elastically deformed radially outward. The connector body 10 has a guide surface 16 that is formed radially outwardly of the first restricting surface 13 and guides the locking claw 24 in the direction toward the fully locked position when the legs 22 are further elastically deformed radially outward.

Therefore, when inserting the pipe 3 into the hollow channel 10a of the connector body 10, the detecting claw 23 contacts the pipe body 4 of the pipe 3 and moves radially (left-right direction) outward. The legs 22 bend to expand radially outward to accumulate elastic energy. The locking claw 24 moves radially outward in the guide groove 15. The first restricting surface 13 restricts the movement of the locking claw 24 in the removal direction, and the second restricting surface 14 restricts the movement of the locking claw 24 in the direction to the fully locked position. Therefore, with the retainer 20 held in the temporary locked position, the amount of deformation in the radial direction corresponding to the approximate diameter of the pipe body is ensured such that elastic energy is accumulated in the legs 22. This suppresses energy loss and allows for efficient accumulation of elastic energy. When the detecting claw 23 contacts the bulge 5, the locking claw 24 moves further radially outward and comes in contact with the guide surface 16 while accumulating even more elastic energy. The guide surface 16 forcibly moves the locking claw 24 in the direction toward the fully locked position. At this time, the function of the second restricting surface 14 to restrict the movement of the locking claw 24 in the direction toward the fully locked position is no longer present. Therefore, the accumulated elastic energy of the legs 22, which was generated by the legs 22 being pressed in the radial direction by the bulge 5, is released as the bulge 5 has reached between the pair of the detecting claws 23 in the axial direction such that the pair of the legs 22 swiftly move from the temporary locked position to the direction toward the fully locked position. Thus, as much as possible deformation amount of the legs 22 in the radial direction can be converted into sufficient energy for the retainer 20 to move from the temporary locked position to the fully locked position. Therefore, the retainer 20 can be provided in a compact structure with reduced rigidity. This allows the connector 1 to be compact.

As shown in FIGS. 13 and 14, when the retainer 20 opens its legs 22 in the radial direction while the pipe body 4 is in contact with the detecting claws 23 near the horizontal plane passing through the axis J in the temporary locked position, the interval between the pair of legs 22 becomes wider at the ends 22a, and the force in the removal direction generated in the retainer 20 is restricted by the first restricting surface 13 of the connector body 10. Therefore, the amount of deformation of the legs 22 in the radial direction can be increased in the temporary locked position. Therefore, the opening width at the ends 22a of both legs 22 becomes in a size corresponding to the maximum outer diameter of the pipe body 4. This allows a large amount of elastic energy to be accumulated in the legs 22. In addition, the force in the removal direction of the retainer 20 can be restricted by the first restricting surface 13. Therefore, the leg 22 can ensure a radial deformation amount that corresponds to the approximate diameter of the pipe body 4. Following this motion, the legs 22 deform further in the radial direction due to the bulge 5, thereby accumulating even more elastic energy. Overall, there is no need to increase the rigidity of the legs 22 as the deformation amount is ensured. Thus, sufficient elastic energy can be accumulated in the compactly designed legs 22 to move the retainer 20 from the temporary locked position to the fully locked position.

As shown in FIGS. 2, 9, and 12, the detecting claw 23 is provided on the end 22a of the leg 22 and has an inclined surface 23a that is inclined toward the insertion direction on the front side of the insertion direction of the pipe 3. Therefore, when the end 4a of the pipe 3 contacts the inclined surface 23a, the force to insert the pipe 3 in the axial direction can be efficiently converted into a force to open the legs 22 radially outward. Furthermore, by providing the inclined surface 23a at the end 22a of the legs 22, the legs 22 can be opened radially outward using the principle of leverage. Therefore, the leg 22 can be made shorter, and the connector 1 may be made compact after the pipe 3 is assembled.

As shown in FIGS. 6, 12, and 13, the second restricting surface 14 may be inclined to approach the first restricting surface 13 toward the radially outward direction. Therefore, the inclination of the second restricting surface 14 can prevent unintended movement of the retainer 20, even when, for example, a force to press the retainer 20 in the direction toward the fully locked position is applied while the retainer 20 is positioned in the temporary locked position.

As shown in FIGS. 6 and 14, the guide surface 16 may be formed to be planar. Therefore, the locking claw 24 smoothly moves along the planar guide surface 16 when it moves to the fully locked position. This helps to reduce energy loss due to the contact between the locking claw 24 and the guide surface 16.

As shown in FIGS. 10 to 12, the connector body 10 may have a guide inclined surface 18 that extends radially outward and upward from an inner end of the first restricting surface 13. The guide inclined surface 18 may be inclined to guide the locking claw 24 radially inward when the retainer 20 is temporarily locked to the connector body 10. Therefore, the locking claw 24 is guided to the temporary locked position in the guide groove 15 by the guide inclined surface 18 and is prevented from being removed out of the guide groove 15. Furthermore, the locking claw 24 can be guided along the guide inclined surface 18 by a simple operation to insert the retainer 20 into the connector body 10. This allows the retainer body 21 to be easily assembled so as not to be removed out of the connector body 10.

As shown in FIGS. 4 and 15, the retainer 20 may have a retainer body 21 with a pair of legs 22 extending from both ends. The retainer 20 may have an auxiliary removal stopper piece 21a protruding from the retainer body 21 in the same direction as the extending direction of the legs 22. The auxiliary removal stopper piece 21a may axially face the bulge 5 inserted into the hollow channel 10a to prevent the pipe 3 from being removed from the connector body 10. Therefore, the removal stopper piece 25 and the auxiliary removal stopper piece 21a work together to more reliably prevent the pipe 3 from being removed from the connector body 10. Moreover, the auxiliary removal stopper piece 21 may be provided while maintaining the retainer 20 compact.

As shown in FIG. 2, the locking claw 24 may extend from the leg 22 in the insertion direction of the pipe 3. Therefore, the first restricting surface 13, the second restricting surface 14, the guide groove 15 and the guide surface 16, which are engaged with the locking claw 24, are disposed at the rear of the insertion direction of the pipe 3. Therefore, the protrusion amount of the connector body 10 in the insertion direction can be suppressed. This allows the connector 1 to be compact.

Various modifications may be made to the connector 1 according to the present embodiments described above. The connector body 10 and the retainer 20 made of synthetic resin have been described as an example. Alternatively, for example, the connector body 10 or the retainer 20, or both, may be made of metal such as aluminum. The pipe 3 may also be made of metal or synthetic resin.

The locking claw 24 protruding from the leg 22 in the pipe insertion direction (forward), and the first restricting surface 13, the second restricting surface 14, the guide surface 16, the lock surface 17, and the guide inclined surface 18 provided on the rear side of the front wall 12 and engaged with the locking claw 24 have been described as examples. Alternatively, the locking claw 24 may be configured to protrude rearward from the leg 22, and the first restricting surface 13, the second restricting surface 14, the guide surface 16, the lock surface 17, and the guide inclined surface 18 that engage with the locking claw 24 may be provided on the front side of the rear wall 11.

A configuration has been described as an example in which the leg 22 of the retainer 20 is provided with a convex-shaped locking claw 24 and the connector body 10 is provided with a concave-shaped channel that is engaged with the locking claw 24 through a concave-convex engagement. Alternatively, for example, it may be a configuration provided with a concave groove extending in the left-right direction in the leg 22 of the retainer 20 and a convex portion on the rear side of the front wall 12 with lateral sides of the convex portion serving as the first restricting surface 13, the second restricting surface 14, the guide surface 16, the lock surface 17, and the guide inclined surface 18. A configuration has been described as an example in which the guide surface 16 is provided continuously with the first restricting surface 13. Alternatively, for example, a configuration may be adopted in which an interval shorter than the left-right width of the locking claw 24 may be provided between the guide surface 16 and the first restricting surface 13, while the guide surface 16 and the first restricting surface 13 are non-continuous.

The left-right or up-down position of the locking claw 24 in the leg 22 may be changed as appropriate. For example, the outer surface 24c of the locking claw 24 may be positioned more inward in the left-right direction than the outer surface of the leg 22. A removal stopper piece 25 provided on the leg 22 and connected at the upper end to the retainer body 21 has been described as an example. Alternatively, for example, the removal stopper piece 25 may not be directly connected to the retainer body 21. A retainer 20 has been described as an example in which the legs 22 are substantially orthogonal to the retainer body 21 and has a substantially U-shape as viewed from the front-rear direction. Instead, for example, a base end of each leg 22 may be connected in an arc shape with respect to both ends of the retainer 20, and the retainer 20 may be provided in a substantially C-shape similar to a horseshoe shape as viewed from the front-rear direction.

A configuration has been described as an example in which both of the pair of legs 22 are provided with a detecting claw 23 and a locking claw 24. Alternatively, a configuration may be adopted in which only one of the legs 22 is provided with the detecting claw 23 and the locking claw 24. A configuration has been described as an example in which one end of the pipe portion serves as the pipe connecting portion 2a and the other end serves as the tube connecting portion 2b, and the connector body 10 is provided only on the side of the pipe connecting portion 2a. Alternatively, a configuration may be adopted in which both ends of the pipe portion 2 serve as connecting portions 2a, with the connector body 10 being provided at both pipe connecting portions 2a to allow the retainer 20 to be attached to each connector body 10. Although a pipe 2 of an elbow type is described, the pipe 2 may be a straight type. It may be a two-piece structure with any type of pipe, regardless of whether the pipe is elbow or straight, in any combination as needed. Although a configuration has been described as an example in which the locking claw 24 is provided closer to the end 22a of the leg 22 at substantially the same level as the detecting claw 23, the locking claw 24 may be provided on the side closer to the retainer body 21. In this case, the first restricting surface 13 and the second restricting surface 14, which define the guide groove 15 are formed on the connector body 10 corresponding to the arrangement of the locking claw 24.

1. A connector for connecting pipes comprising:
a connector body having a hollow channel; and
a retainer configured to lock a pipe, wherein the pipe is inserted into the hollow channel in an axial direction to the connector body,
wherein the retainer includes
a pair of legs inserted into the connector body along a plane orthogonal to the axial direction,
a detecting claw positioned on the pair of legs, the detecting claw being configured to contact a bulge of the pipe to allow the pair of legs to elastically deform radially outward when the pipe is inserted,
a removal stopper piece opposing the bulge in the axial direction when the pipe is inserted to prevent the pipe from being removed from the connector body, and
a locking claw protruding in the axial direction from the leg,
wherein the connector body includes
a first restricting surface configured to hold the retainer in a temporary locked position by restricting a movement of the locking claw of the retainer inserted into the connector body in a removal direction,
a second restricting surface configured to restrict a movement of the locking claw from the temporary locked position to a fully locked position,
a guide groove provided between the first restricting surface and the second restricting surface to allow the locking claw to move in a radial direction when the pair of legs is elastically deformed radially outward, and
a guide surface formed radially outwardly from the first restricting surface and configured to guide the locking claw in a direction toward the fully locked position when the pair of legs is further elastically deformed radially outward.

2. The connector according to claim 1, wherein an interval between the pair of legs is configured to be larger at an end when the pipe body exceeds the detecting claw in the axial direction when the retainer is in the temporary locked position, and a force in a removal direction generated in the retainer is restricted by the first restricting surface of the connector body.

3. The connector according to claim 1, wherein the detecting claw is provided at an end of the pair of legs, and wherein the detecting claw includes an inclined surface on a front side of a pipe insertion direction that is inclined with respect to the insertion direction.

4. The connector according to claim 2, wherein the detecting claw is provided at an end of the pair of legs, and wherein the detecting claw includes an inclined surface on a front side of a pipe insertion direction that is inclined with respect to the insertion direction.

5. The connector according to claim 1 , wherein the second restricting surface is inclined to approach the first restricting surface toward the radially outward direction.

6. The connector according to claim 1, wherein the guide surface is planar.

7. The connector according to claim 1, wherein the connector body has a guide inclined surface on an opposite side of the first restricting surface in a direction toward the fully locked position, and
wherein the guide inclined surface is inclined to guide the locking claw radially inward when the retainer is temporarily locked to the connector body.

8. The connector according to claim 1, wherein the retainer has a retainer body with the pair of legs extending from both ends, and an auxiliary removal stopper piece protruding from the retainer body in the same direction as the extending direction of the pair of legs,
wherein the auxiliary removal stopper piece axially opposes the bulge inserted into the hollow channel to prevent the pipe from being removed from the connector body.

9. The connector according to claim 1, wherein the locking claw is extendable from the pair of legs in a pipe insertion direction.
